(19) United States
(12) Patent Application Publication
(10) Pub. No.: US 2006/0131800 A1
(43) Pub. Date: Jun. 22, 2006

(54) Vibration-damping bushing assembly

(75) Inventors: Hiroaki Hori, Inuyama-shi (JP); Masaaki Mishima, Kasugai-shi (JP)

Correspondence Address: OLIFF & BERRIDGE, PLC, P.O. BOX 19928, ALEXANDRIA, VA, 22320, US

(73) Assignee: TOKAI RUBBER INDUSTRIES, LTD., Komaki-shi (JP)

(21) Appl. No.: 11/281,500

(22) Filed: Nov. 18, 2005

(30) Foreign Application Priority Data
Nov. 22, 2004 (JP) 2004-338062

(51) Int. Cl. F16F 1/44

(52) U.S. Cl. 267/293; 267/136

(57) ABSTRACT

A vibration-damping bushing assembly wherein a vibration-damping bushing is axially press-fit into a rigid cylindrical retainer of a companion member to be assembled therewith at an outer circumferential surface of an outer cylindrical member of the bushing. A rigid spacer ring band, of annular shape, is mounted while externally fitted by means of axial pressure on the circumferential surface of the outer cylindrical member. A flange of the outer cylindrical member and an end surface of the cylindrical retainer are brought into axial contact through the spacer ring band, and the spacer ring band is partially provided with at least one protrusion protruding on an inner circumferential surface so as to be fitted and fixed to the outer cylindrical member at the protrusion. A vibration-damping bushing and a rigid spacer ring band for the assembly are also disclosed.

### INCORPORATED BY REFERENCE

The disclosure of Japanese Patent Application No. 2004-338062 filed on Nov. 22, 2004 including the specification, drawings and abstract is incorporated herein by reference in its entirety.

### BACKGROUND OF THE INVENTION

1. Field of the Invention

The present invention relates to a vibration-damping bushing comprising a rubber elastic body interposed between a rigid outer cylindrical member and inner cylindrical member, and a vibration-damping bushing assembly for fitting, mounting, and fixing the vibration-damping bushing to a rigid cylindrical retainer of a companion member.

2. Description of the Related Art

Conventionally, vibration-damping bushings with a rubber elastic body interposed between a rigid, outer cylindrical member having a flange in the radial outward direction at the axial end and a rigid inner cylindrical member disposed inside have been widely used as suspension bushings and the like elastically joining vehicle bodies and suspension arms. This type of vibration-damping bushing is ordinarily axially fitted to be mounted and fixed to a rigid cylindrical retainer of a companion member on the circumferential surface of an outer cylindrical member.

This type of vibration-damping bushing was specially made according to the type of vehicle or to the type or shape of the companion member, and was then mounted and fixed to the companion member. For example, in the case of suspension bushings disposed in coupling components between vehicle bodies and suspension arms, special vibration-damping bushings are produced according to the different types and shapes of the suspension arms serving as the companion member. However, the costs for such vibration-damping bushings are inevitably high.

One major to reduce the costs of such vibration-damping bushings would be to devise a single type of vibration-damping that could be shared, that is, one that could be used universally, regardless of the type or shape of companion members such as suspension arms. However, attempts to do so, have resulted in an axial gap between the end surface of the cylindrical retainer and the flange at the end of the outer cylindrical member, as the axial mounting positions of the vibration-damping bushing and cylindrical retainer are variable depending on the type and shape of the companion member.

When such a gap is produced between the end surface of the cylindrical retainer and the outer cylindrical member, a resulting problem is that the vibration-damping bushing is axially displaced from the proper mounting position relative to the cylindrical retainer when axial force is exerted on the vibration-damping bushing by input force on the vehicle. Particularly when the cylindrical retainer of the companion member is formed by a pressing process such as burring, the axial length of the cylindrical retainer cannot be lengthened, resulting in a shorter axial fitting length between the cylindrical retainer and the vibration-damping bushing, specifically, the outer cylindrical member, and thus in less frictional contact area. This results in weaker retention force on the vibration-damping bushing by the cylindrical retainer, and greater susceptibility to axial displacement of the vibration-damping bushing. This is illustrated in detail by FIG. 8.

In FIG. 8, 200 is the vibration-damping bushing, which comprises an outer cylindrical member (rigid outer cylindrical member) 202 and inner cylindrical member (rigid inner cylindrical member) 204, with a rubber elastic body 206 interposed between the outer cylindrical member 202 and inner cylindrical member 204 to be integrally bonded by vulcanization to join the outer cylindrical member 202 and inner cylindrical member 204 in the radial direction. The outer cylindrical member 202 has a radially outward-facing annular flange 208 at the axial

210 is a suspension arm serving as the companion member, the end of which is provided with a cylindrical retainer 212 formed by a pressing process such as burring. The cylindrical retainer 212 has an mounting hole 214 on the inside, where the vibration-damping bushing 200 is axially fitted at the outer circumferential surface of the outer cylindrical member 202 to be mounted and fixed.

FIG. 8 illustrates the vibration-damping bushing 200 and suspension arm 210, specifically, the cylindrical retainer 212, mounted in the proper mounting position. An axial gap x is produced between the end surface of the cylindrical retainer 212 and the flange 208 of the outer cylindrical member 202 of the vibration-damping bushing 200 in this state. When such a gap x occurs between the end surface of the cylindrical retainer 212 and the flange 208, a resulting problem is that the vibration-damping bushing 200 tends to become axially displaced relative to the cylindrical retainer 212, because of the relatively weak retaining force by the cylindrical retainer 212 formed by a pressing process, whenever axial force is exerted on the vibration-damping bushing 200 by force on the vehicle.

As a way to address this problem, a rigid spacer ring band 216 made of metal or the like, which as illustrated in FIG. 9A is in the form of a circumferentially continuous ring and is in the form of a band thick enough as a whole to correspond to the gap x, is mounted while externally fitted by means of axial pressure on the circumferential surface of the outer cylindrical member 202, and the spacer ring band 216 is interposed between the flange 208 and the cylindrical retainer 212 end surface, that is, the vibration-damping bushing 200 is assembled therewith at the cylindrical retainer 212, with the flange 208 and cylindrical retainer 212 end surface brought into contact through the spacer ring band 216. As this allows the axial gap between the flange 208 and the cylindrical retainer 210 end surface to be filled up by the spacer ring 216, thereby preventing the vibration-damping bushing 200 from becoming displaced relative to the cylindrical retainer 212 when axial force is exerted on the vibration-damping bushing 200.

JP-U-60-75734 describes a slip-proof rubber bushing in which the outer cylindrical member is formed with hard plastic, and the cylindrical retainer of the companion member is provided with a protrusion on the inner circumference to allow the protrusion to bite into the outer cylindrical member, thus preventing the rubber bushing from slipping in the axial direction, but unlike the present invention, this does not involve the use of a spacer ring band to mount a vibration-damping bushing.

JP-A-9-68246 below discloses an invention regarding an elastic bushing, in which the flange of the outer cylindrical member of the vibration-damping bushing has different levels in the axial direction, so that the axial gap between the vibration-damping bushing and the bracket on the companion side is filled in based on the difference in levels, but unlike the present invention, this does not involve the use of a spacer ring band.

### SUMMARY OF THE INVENTION

It is therefore one object of this invention to provide a vibration-damping bushing and a vibration-damping bushing assembly which can be used as a shared vibration-damping bushing regardless of differences in the type of vehicle or in the type or shape of companion members, and which in such cases allows enough pressure-based fixing force to be achieved without axial displacement of the vibration-damping bushing relative to the cylindrical retainer of the companion member.

As a way to address this problem, the present inventors has proposed that a rigid spacer ring band 216 made of metal or the like, which as illustrated in FIG. 9A is in the form of a circumferentially continuous ring and is in the form of a band thick enough as a whole to correspond to the gap x (see FIG. 8), is mounted while externally fitted by means of axial pressure on the circumferential surface of the outer cylindrical member 202, and the spacer ring band 216 is interposed between the flange 208 and the cylindrical retainer 212 end surface, that is, the vibration-damping bushing 200 is assembled therewith at the cylindrical retainer 212, with the flange 208 and cylindrical retainer 212 end surface brought into contact through the spacer ring band 216. As this allows the axial gap between the flange 208 and the cylindrical retainer 210 end surface to be filled up by the spacer ring 216, thereby preventing the vibration-damping bushing 200 from becoming displaced relative to the cylindrical retainer 212 when axial force is exerted on the vibration-damping bushing 200.

The spacer ring band 216 is mounted by pressure onto the outer cylindrical member 202 before the vibration-damping bushing 200 is assembled therewith at the cylindrical retainer 212, but this has been found to result in the following problems. That is, when the entire internal circumferential surface of the spacer ring band 216 is tightly fixed (mounted) by axial pressure relative to the outer circumferential surface of the outer cylindrical member 216, the outside diameter of the outer cylindrical member 202 is constricted by the pressure at that time, and when the vibration-damping bushing 200 is then fitted to the cylindrical retainer 212, there is a change (a reduction) in the fixing force by means of pressure due to the change in the dimensions of the outer cylindrical member 202, preventing the desired fixing force from being obtained.

As a way to address this problem, the outer cylindrical member 202 has a stepped configuration comprising a large diameter component 202A and a small diameter component 202B, as illustrated in FIG. 9B, the spacer ring band 216 is fixed by pressure to the large diameter component 202A, and the small diameter component 202B of the outer cylindrical member 202 is fitted to and mounted in the cylindrical retainer 212. However, in this case, the pressure of the spacer ring band 216 on the large diameter component 202A deforms (constricts) the small diameter component 202B, making this an unsuitable way to address the problem.

In view of the above, the present inventors further improve the invention, and the above and/or optional objects of this invention may be attained according to at least one of the following modes of the invention. The following modes and/or elements employed in each mode of the invention may be adopted at any possible optional combinations. It is to be understood that the principle of the invention is not limited to these modes of the invention and combinations of the technical features, but may otherwise be recognized based on the teachings of the present invention disclosed in the entire specification and drawings or that may be recognized by those skilled in the art in the light of the present disclosure in its entirety.

A first mode of the invention provides a vibration-damping bushing assembly wherein a vibration-damping bushing including: a rigid outer cylindrical member having a radially outward-facing flange at one axial end; a rigid inner cylindrical member disposed inside the outer cylindrical member; and a rubber elastic body interposed between and elastically connecting the outer and inner cylindrical members, and wherein the vibration-damping bushing is axially press-fit into a rigid cylindrical retainer of a companion member to be assembled therewith at an outer circumferential surface of the outer cylindrical member, characterized in that a rigid spacer ring band of annular shape is mounted while externally fitted by means of axial pressure on the circumferential surface of the outer cylindrical member, the flange of the outer cylindrical member and an end surface of the cylindrical retainer being brought into axial contact through the spacer ring band, and the spacer ring band is partially provided with at least one protrusion protruding on an inner circumferential surface so as to be fitted and fixed to the outer cylindrical member at the protrusion.

A second mode of the invention provides a vibration-damping bushing assembly according to the first mode, wherein the at least one protrusion comprises a plurality of protrusions that are provided in a plurality of locations at intervals in a circumferential direction.

A third mode of the invention provides a vibration-damping bushing assembly according to the second mode, wherein the plurality of protrusions are provided in one or a plurality of locations at intervals in an axial direction.

A fourth mode of the invention provides a vibration-damping bushing assembly according to the second mode, wherein a portion of the spacer ring band located between the adjacent protrusions are in a suspended state not in contact with the outer cylindrical member so that a gap is produced between the band and the outer cylindrical member, and the radial deformability is greater due to the gap when pressure is exerted on the portions between the protrusions.

A fifth mode of the invention provides a vibration-damping bushing assembly according to any one of the first through fourth modes, wherein the cylindrical retainer is made of metal and is formed by a pressing process.

A sixth mode of the invention provides a vibration-damping bushing comprising: a rigid outer cylindrical member having a radially outward-facing flange at one axial end; a rigid inner cylindrical member disposed inside the outer cylindrical member; and a rubber elastic body interposed between and elastically connecting the outer and inner cylindrical members, and wherein the vibration-damping bushing is adapted to be axially press-fit into a rigid cylindrical retainer of a companion member to be assembled therewith at an outer circumferential surface of the outer cylindrical member; and a rigid spacer ring band of annular shape adapted to be mounted while externally fitted by means of axial pressure on the circumferential surface of the outer cylindrical member, so as to be interposed between the flange of the outer cylindrical member and an end surface of the cylindrical retainer, the spacer ring band being partially provided with at least one protrusion protruding on an inner circumferential surface so as to be fitted and fixed to the outer cylindrical member at the protrusion.

A seventh mode of the invention provides A rigid spacer ring band for use in a vibration damping bushing assembly wherein a vibration-damping bushing including: a rigid outer cylindrical member having a radially outward-facing flange at one axial end; a rigid inner cylindrical member disposed inside the outer cylindrical member; and a rubber elastic body interposed between and elastically connecting the outer and inner cylindrical members, and wherein the vibration-damping bushing is adapted to be axially press-fit into a rigid cylindrical retainer of a companion member to be assembled therewith at an outer circumferential surface of the outer cylindrical member, characterized in that: said rigid spacer ring of annular shape is in the form of a band as a whole, and is adapted to be mounted while externally fitted by means of axial pressure on the circumferential surface of the outer cylindrical member so that the flange of the outer cylindrical member and an end surface of the cylindrical retainer being brought into axial contact through the spacer ring band; and the spacer ring band being partially provided with at least one protrusion protruding on an inner circumferential surface so as to be fitted and fixed to the outer cylindrical member at the protrusion.

As noted above, the present invention is one in which the spacer ring band is partially provided with protrusions protruding on the inner circumferential side. According to the invention, less pressure force is needed than when the spacer ring band is fitted and tightly fixed along the entire inner circumferential surface to the outer circumferential surface of the outer cylindrical member of the vibration-damping bushing, and there is less radially constricting force exerted on the outer cylindrical member, resulting in substantially no radially constricting deformation of the outer cylindrical member, thereby ensuring the set tightening, that is, fixing force, when the vibration-damping bushing is subsequently fitted to the cylindrical retainer of the companion member.

While thus mounted and fixed, the spacer ring band is interposed between the flange of the outer cylindrical member and the end surface of the cylindrical retainer to allow the spacer ring band to fill up the axial gap between flange and the end surface of the cylindrical retainer, thus ensuring that the vibration-damping bushing is prevented from becoming displaced relative to the cylindrical retainer when axial force is imposed on the vibration-damping bushing by force on the vehicle.

In the present invention, the protrusions can be provided in a plurality of locations at intervals in the circumferential direction (Second mode). This can bring about radial deformability in the portions (circumferential portions) of the spacer ring band between the protrusions, and the dimensional differences occurring when pressure is exerted on the spacer ring band can be effectively absorbed by the radial deformation of the portions between the protrusions. That is, despite irregularities in the outside diameter of the outer cylindrical member and the inside diameter of the spacer ring band, the desired fixing force by pressure on the spacer ring band can be ensured, and substantial constricting force from the spacer ring band on the outer cylindrical member can be prevented.

In this case, the protrusions can be provided in a continuous linear formation in the axial direction, but protrusions can also be provided in one location or at intervals in a plurality of locations in the axial direction (Third mode). It is more desirable to provide one in one location in the axial direction, as this will allow enough pressure to be obtained to fix the spacer ring band while also minimizing constricting force from the spacer ring band onto the outer cylindrical member.

The protrusions are preferably provided in three locations at 120° intervals in the circumferential direction. This will allow the spacer ring band to be fitted and fixed to the outer cylindrical member with uniform force at the protrusions.

In the fourth mode, the portions of the spacer ring band in the circumferential direction between the protrusions are in a suspended state not in contact with the outer cylindrical member, so that a gap is produced between the band and the outer cylindrical member, and the radial deformability between the protrusions is greater due to the gap. Thus, the above effects are more effectively brought about based on the greater deformability.

The present invention is particularly effective in applications where the cylindrical retainer of the companion member is made of metal and is formed by a pressing process (Fifth mode). A vibration damping bushing as well as a rigid spacer ring band, which are suitable for executing the aforementioned assembly according to the present invention, are also provided (Sixth mode and Seventh mode).

### BRIEF DESCRIPTION OF THE DRAWINGS

The forgoing and/or other objects features and advantages of the invention will become more apparent from the following description of a preferred embodiment with reference to the accompanying drawings in which like reference numerals designate like elements and wherein:

FIG. 1 is partial cross sectional plane view of a vibration damping bushing assembly with a suspension arm serving as a companion member;

FIG. 2 is a fragmentary view showing a principle part of FIG. 1;

FIG. 3 is a cross sectional view taken along line 3-3 of FIG. 2;

FIG. 4 is a perspective view showing a vibration damping bushing of the assembly of FIG. 1;

FIGS. 5A, 5B and 5C show one form of a spacer ring band in perspective, in transverse cross section and in axial cross section, respectively;

FIGS. 6A and 6B are views suitable for explaining a method of assembly of the bushing;

FIGS. 7A, 7B and 7C show another form of the spacer ring band in perspective, in transverse cross section and in axial cross section, respectively;

FIG. 8 shows a conventional vibration damping bushing assembly of construction;

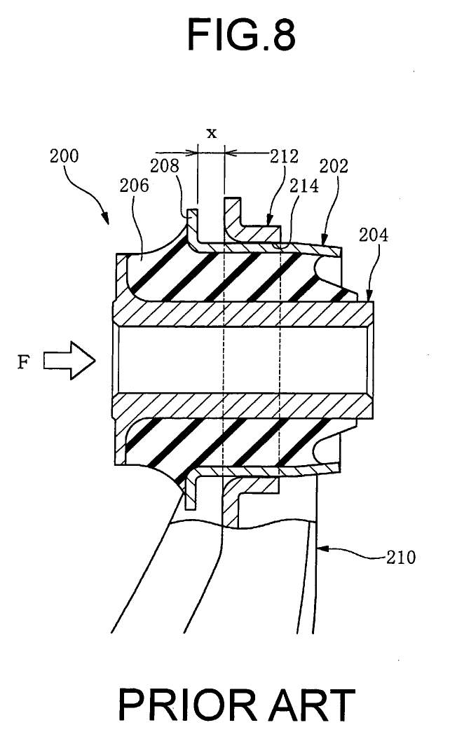

FIGS. 9A and 9B show trial measures proposed by the inventors for solving a problem involved in the conventional assembly in FIG. 8;

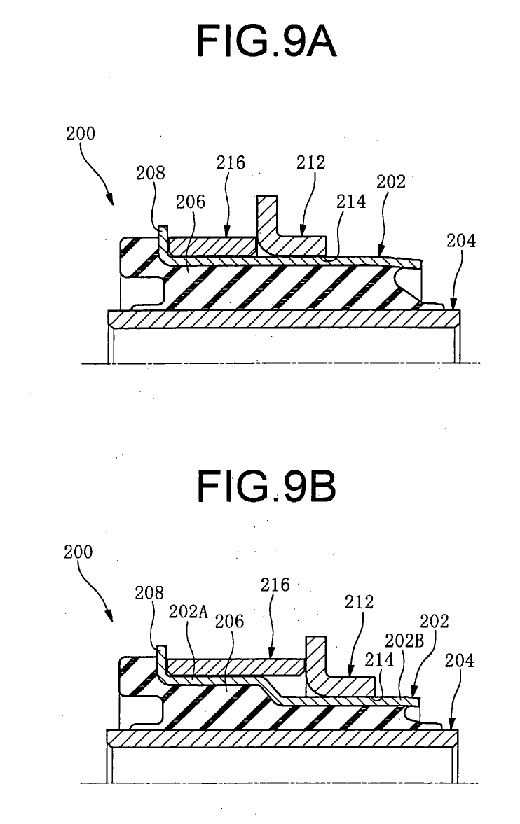

FIGS. 10A and 10B show another form of the spacer ring band in perspective, in transverse cross section and in axial cross section, respectively;

FIGS. 11A and 11B show another form of the spacer ring band in perspective, in transverse cross section and in axial cross section, respectively; and

FIGS. 12A and 12B show another form of the spacer ring band in perspective, in transverse cross section and in axial cross section, respectively.

### DETAILED DESCRIPTION OF PREFERRED EMBODIMENTS

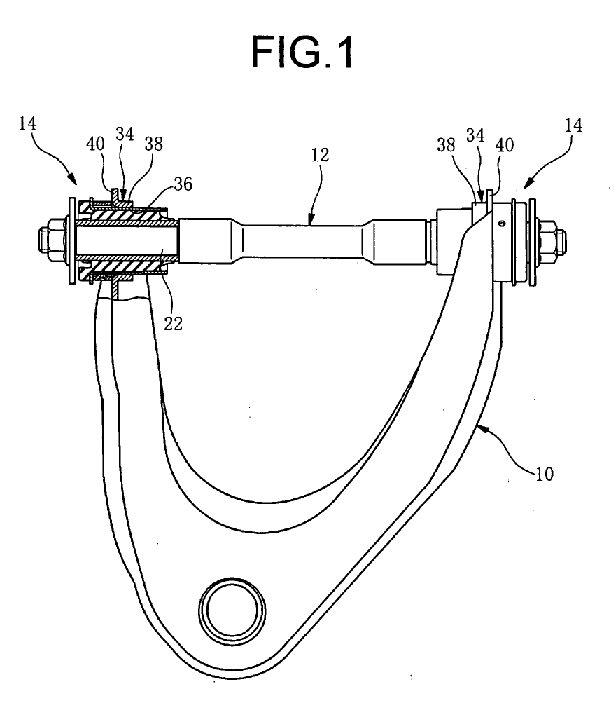

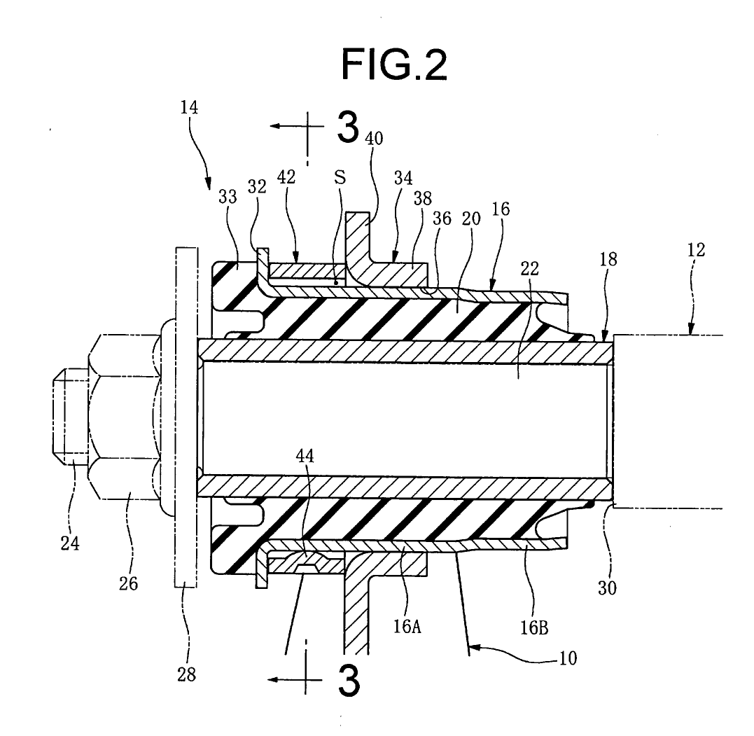

Preferred embodiments of the invention in suspension bushing assemblies will be described in greater detail with reference to the drawings. FIG. 1 shows a suspension arm 10, referred to as a so-called A arm, serving as a companion member, for linking a vehicle body and wheel. In FIG. 1, a bottom end of the suspension arm 10 is joined to a wheel side, and a top end is joined to a shaft 12 fixed to the vehicle body. A vibration-damping bushing 14 is disposed in the part connecting the suspension arm 10 and shaft 12. The specific assembly is illustrated in FIG. 2.

As illustrated in FIG. 2, the vibration-damping bushing 14 has a metallic outer cylindrical member (rigid outer cylindrical member) 16 and a metallic inner cylindrical member (rigid inner cylindrical member) 18 disposed on the inside, with a cylindrical rubber elastic body 20 interposed between the outer cylindrical member 16 and inner cylindrical member 18 to elastically join them together.

A through shaft 22 of the shaft 12 is inserted into the inner cylindrical member 18 in the vibration-damping bushing 14. The tip of the through shaft 22 is in the form of male threading 24, to which a nut 26 is screwed, so that by means of the tightening force, both end surfaces of the inner cylindrical member 18 are forcibly sandwiched in the axial direction between a metal plate 28 and a stepped portion 30 of the shaft 12.

The outer cylindrical member 16 is formed of a large diameter component 16A and a small diameter component 16B, with a radially outward-facing flange 32 formed in the shape of a ring at the axial end (left end in the figure). The rubber elastic body 20 includes a flange 33 integrally formed in a shape corresponding to the flange 32 on the rubber elastic body 20. The flange 33 serves as an axial rubber stopper.

The suspension arm 10 illustrated in FIG. 1 is formed by bending a metal sheet, and has a cylindrical retainer 34 at the end on the vehicle body side. The cylindrical retainer 34 has a mounting hole 36 on the inside, to which the vibration-damping bushing 14 is axially fitted to be mounted and fixed at the outer circumferential surface of the outer cylindrical member 16. The cylindrical retainer 34 is formed by a pressing process, in this case, a burring process, where 38 is a cylindrical portion serving as the main part, and 40 is a panel shaped component serving as a flange for the cylindrical portion 38.

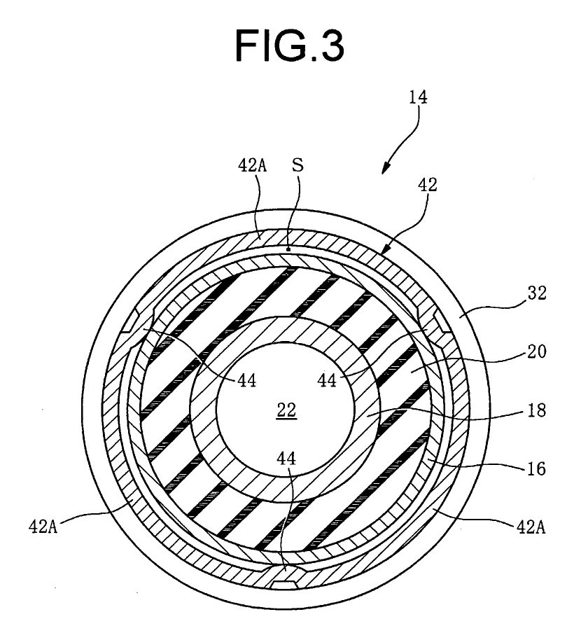

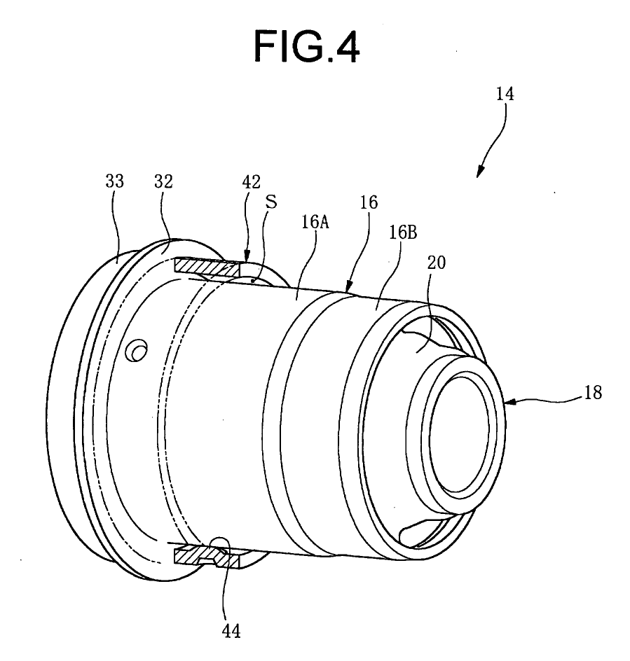

In this embodiment, as illustrated in FIG. 2, the metal spacer ring band 42 is interposed between the end surface of the cylindrical retainer 34 and the flange 32 of the outer cylindrical member 16, the flange 32 and the end surface of the cylindrical retainer 34 coming into axial contact through the spacer ring band 42. As illustrated in FIGS. 3, 4 and 5, the spacer ring band 42 is in the form of a circumferentially continuous round ring, and is also band-shaped with a certain width in the axial direction.

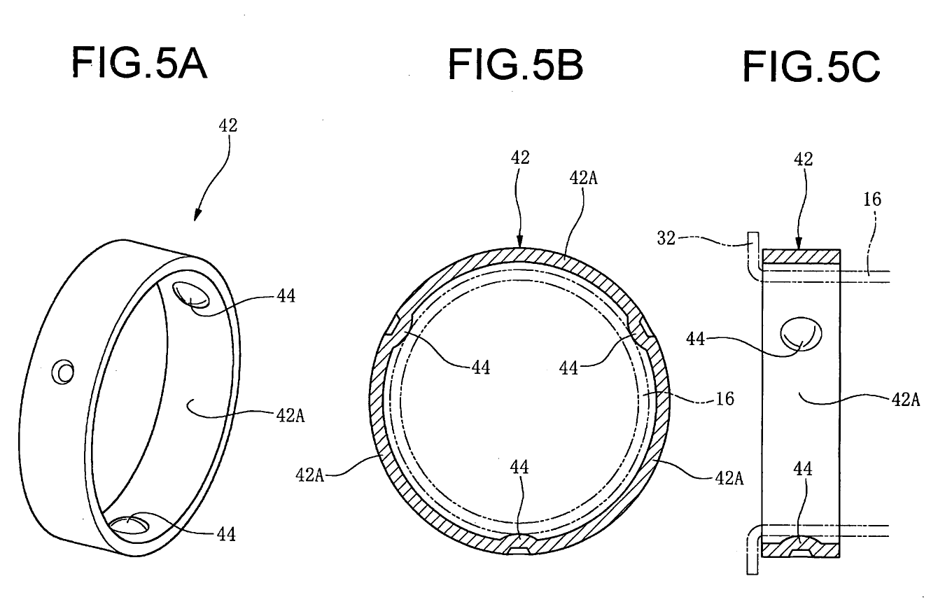

Protrusions 44 formed by forming recesses inwardly from the outer circumferential surface portions of the spacer ring band 42, that is, protrusions 44 protruding on the inner circumference, are provided in three locations (see FIG. 3) in the circumferential direction. Here, the protrusions 44 are provided at locations 120° apart in the circumferential direction. As illustrated in FIG. 5A, the protrusions 44 are discontinuous in the axial direction, the protrusions 44 being provided in only one axial location.

As illustrated in FIGS. 2, 3, and 4, the spacer ring band 42 is axially fitted and fixed to the outer circumferential surface of the outer cylindrical member 16 of the vibration-damping bushing 14 only at the protrusions 44. All of the other portions are in a suspended state not in contact with the outer circumferential surface of the outer cylindrical member 16, forming a gap S between the band and the outer cylindrical member 16. As a result, as illustrated in FIG. 5B, the circumferential portions 42A of the spacer ring band 42 between the protrusion 44 and 44 have substantial radial deformability.

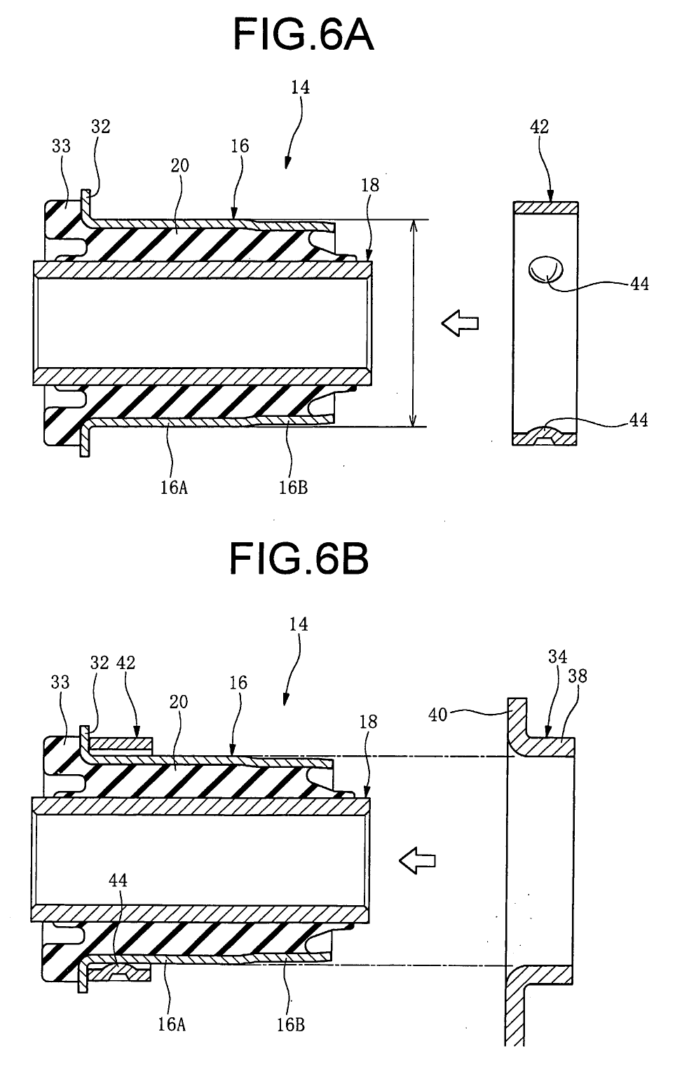

In this embodiment, the vibration-damping bushing 14 is mounted on the cylindrical retainer 34 of the suspension arm 10 in the following manner. That is, as illustrated in FIG. 6A, the spacer ring band 42 is first fitted axially relative to the outer cylindrical member 16 of the vibration-damping bushing 14, and it is mounted on the outer cylindrical member 16 at a location where the front end (left end) of the spacer ring band 42 in the figure comes into contact with the flange 32 of the outer cylindrical member 16. FIG. 6B illustrates the mounted state.

When the spacer ring band 42 is fitted to the outer cylindrical member 16, the spacer ring band 42 comes into frictional contact with the outer circumferential surface of the outer cylindrical member 16 only at the three points where the protrusions 44 are, and the other parts are in a suspended state not in contact with the outer cylindrical member 16. Thus, the tightening force from the spacer ring band 42 to the outer cylindrical member 16 is limited to the three points of the protrusions 44 in the three locations, with substantially no constricting compressive force exerted on the outer cylindrical member 16.

When the spacer ring band 42 is fitted to the outer cylindrical member 16, despite the dimensional variation in the established differences between the outside diameter of the outer cylindrical member 16 and the inside diameter of the spacer ring band 42, it is well absorbed by the radial deformation of the portions 42A between the protrusions 44 and 44. In other words, as a result of the deformability, no excess constricting force acts on the outer cylindrical member 16 by means of the protrusions 44, and the spacer ring band 42 is fitted and fixed with enough fixing force to the outer cylindrical member 16 at the protrusions 44.

After the spacer ring band 42 has thus been mounted on the outer cylindrical member 16, the vibration-damping bushing 14 is fitted axially into the mounting hole 36 of the cylindrical retainer 34 of the suspension arm 10 (up to the point where the spacer ring band 42 is in contact with the end surface of the cylindrical retainer 34). The vibration-damping bushing 14 is mounted on the cylindrical retainer 34 of the suspension arm 10.

In the vibration-damping bushing 14 assembly in the above embodiment, the spacer ring band 42 is fitted and fixed to the outer cylindrical member 16 of the vibration-damping bushing 14 at the three protrusions 44, so that less pressing force is needed than when the spacer ring band 42 is fitted and fixed along the entire inner circumferential surface to the outer circumferential surface of the outer cylindrical member 16. There is also less constricting force (compressive force) exerted on the outer cylindrical member 16, resulting in substantially no radially constricting deformation of the outer cylindrical member 16, thereby ensuring that the desired set fixing force is obtained when the vibration-damping bushing 14 is subsequently fitted to and mounted on the cylindrical retainer 34 of the suspension arm 10.

In addition, because the spacer ring band 42 is interposed between the flange 32 of the outer cylindrical member 16 and the end surface of the cylindrical retainer 34 in the assembly, allowing the axial gap S between the flange 32 and the end surface of the cylindrical retainer 34 to be filled by the spacer ring band 42, the vibration-damping bushing 14 is prevented from becoming displaced relative to the cylindrical retainer 34 even when force on the vehicle results in axial force on the vibration-damping bushing 14. Furthermore, since the protrusions 44 are provided in three locates 120° apart in this embodiment, the spacer ring band 42 is fitted and fixed to the outer cylindrical member 16 with uniform force.

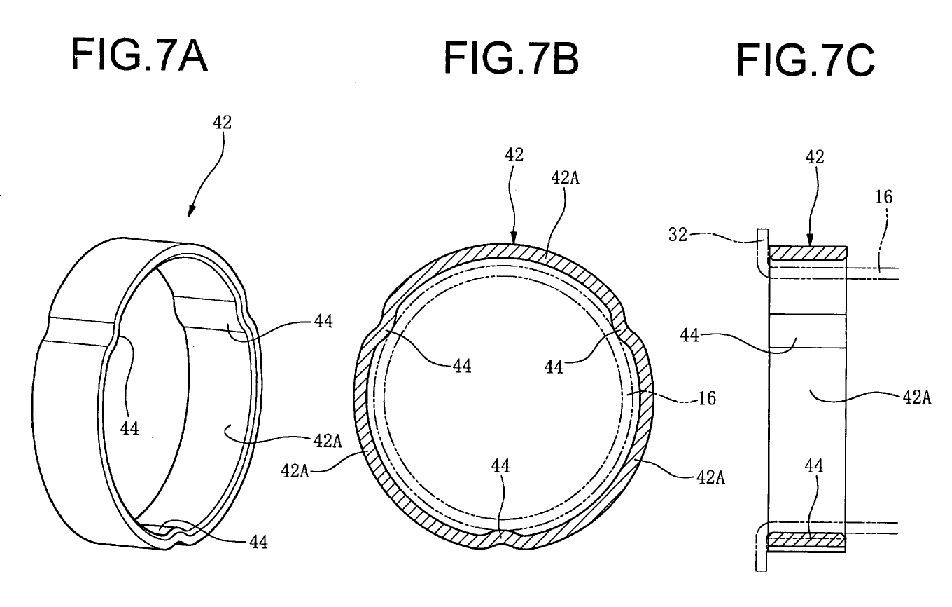

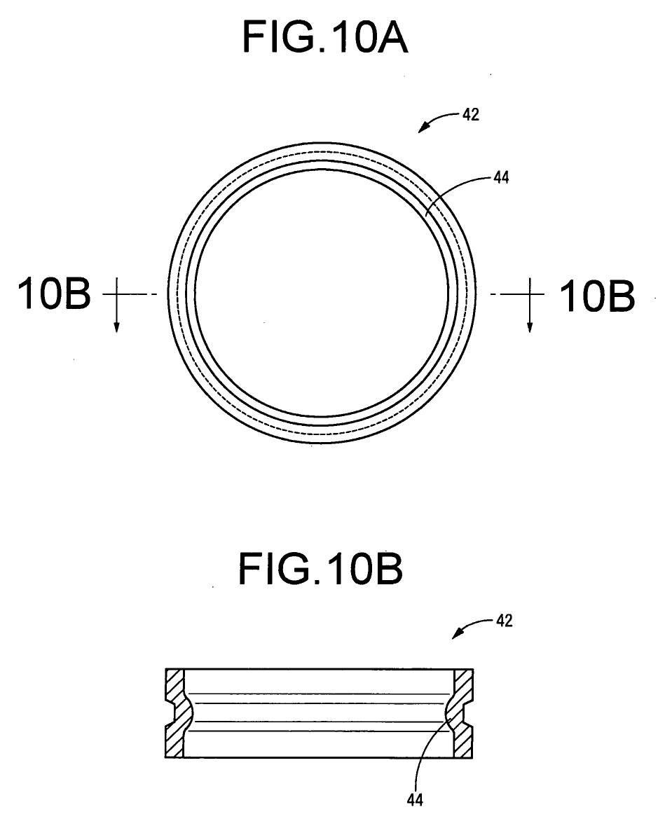

The above embodiments of the inventions were described in detail but are ultimately only examples. For instance, the protrusions 44 of the spacer ring band 42, as shown in FIGS. 7A, 7B and 7C, may have a form continuously extending over an entire axial length of the spacer ring band 42. Alternatively, the protrusions 44, as shown in FIGS. 10A and 10B, may have a form continuously extending over an entire circumferential length of the spacer ring band 42.

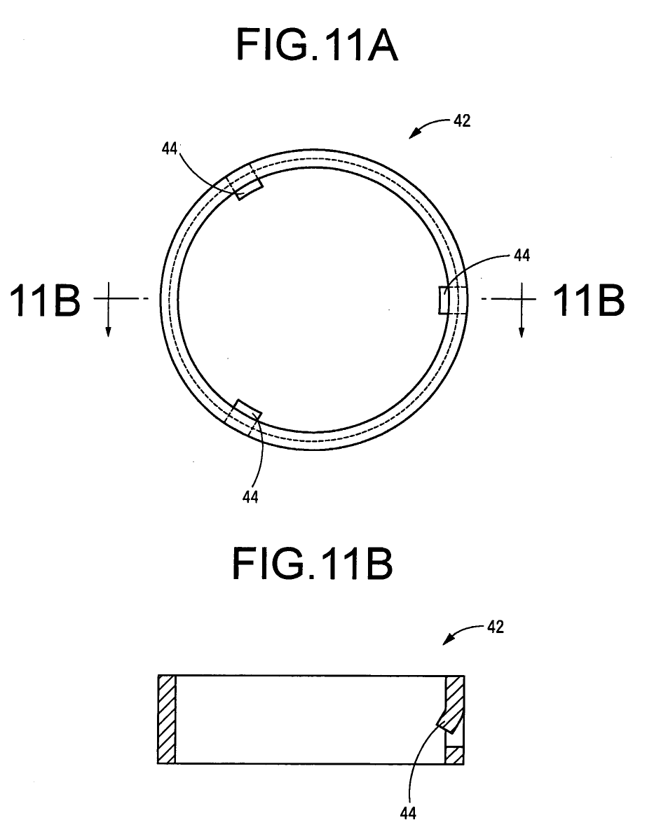

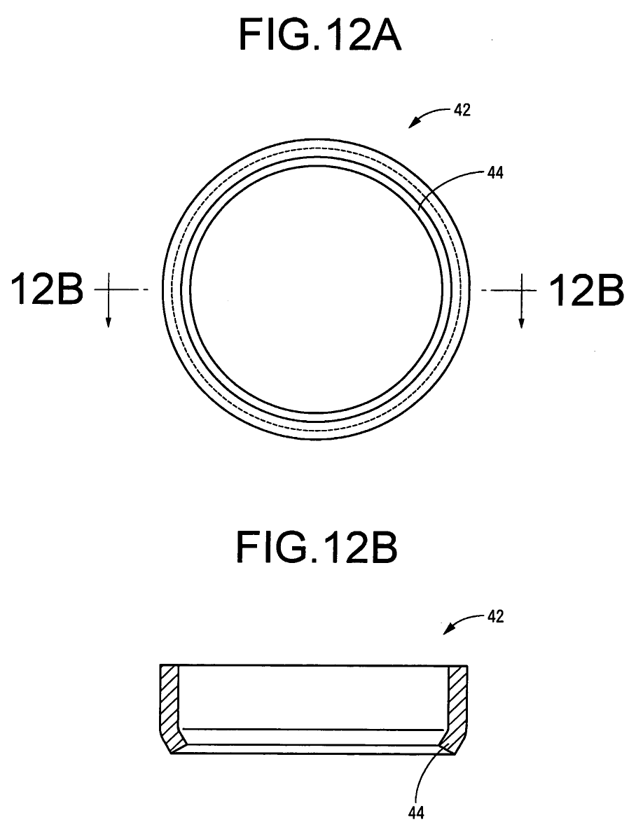

In the illustrated embodiment, the protrusions 44 of the spacer ring band 42 are provided in the form of inward projections by means of pressing. Alternatively, the protrusions 44 may be formed by inwardly bending a part of the circumferential surface of the spacer ring band 42, as shown in FIGS. 11A and 11B. Furthermore, the protrusions 44 may be formed by inwardly bending or drawing one axial end portion of the spacer ring band 42, as shown in FIGS. 12A and 12B. Other possible modification in the form of the protrusion may be employed as long as these are workable to provide the aforementioned effect of the invention.

While the present invention may be suitably employed in the case of assembling the vibration-damping bushing 14 with respect to the retainer 34 formed by burring or other pressing processes, the invention may similarly be applied to the assembly of bushings with respect to retainers of different constructions. Likewise, the present invention may be suitably applicable to the assembly of bushings with respect to retainers formed on companion members other than suspension arms. It is also to be understood that the present invention may be embodied with various changes, modifications and improvements which may occur to those skilled in the art, without departing from the spirit and scope of the invention.

What is claimed is:

1. A vibration-damping bushing assembly wherein a vibration-damping bushing including: a rigid outer cylindrical member having a radially outward-facing flange at one axial end; a rigid inner cylindrical member disposed inside the outer cylindrical member; and a rubber elastic body interposed between and elastically connecting the outer and inner cylindrical members, and wherein the vibration-damping bushing is axially press-fit into a rigid cylindrical retainer of a companion member to be assembled therewith at an outer circumferential surface of the outer cylindrical member, characterized in that
a rigid spacer ring band of annular shape is mounted while externally fitted by means of axial pressure on the circumferential surface of the outer cylindrical member, the flange of the outer cylindrical member and an end surface of the cylindrical retainer being brought into axial contact through the spacer ring band, and the spacer ring band is partially provided with at least one protrusion protruding on an inner circumferential surface so as to be fitted and fixed to the outer cylindrical member at the protrusion.

2. A vibration-damping bushing assembly according to claim 1, wherein the at least one protrusion comprises a plurality of protrusions that are provided in a plurality of locations at intervals in a circumferential direction.

3. A vibration-damping bushing assembly according to claim 2, wherein the plurality of protrusions are provided in one or a plurality of locations at intervals in an axial direction.

4. A vibration-damping bushing assembly according to claim 2, wherein a portion of the spacer ring band located between the adjacent protrusions are in a suspended state not in contact with the outer cylindrical member so that a gap is produced between the band and the outer cylindrical member, and a radial deformability is greater due to the gap when pressure is exerted on the portions between the protrusions.

5. A vibration-damping bushing assembly according to claim 1, wherein the cylindrical retainer is made of metal and is formed by a pressing process.

6. A vibration-damping bushing comprising:
a rigid outer cylindrical member having a radially outward-facing flange at one axial end;
a rigid inner cylindrical member disposed inside the outer cylindrical member; and
a rubber elastic body interposed between and elastically connecting the outer and inner cylindrical members, and wherein the vibration-damping bushing is axially press-fit into a rigid cylindrical retainer of a companion member to be assembled therewith at an outer circumferential surface of the outer cylindrical member; and
a rigid spacer ring band of annular shape adapted to be mounted while externally fitted by means of axial pressure on the circumferential surface of the outer cylindrical member, so as to be interposed between the flange of the outer cylindrical member and an end surface of the cylindrical retainer, the spacer ring band being partially provided with at least one protrusion protruding on an inner circumferential surface so as to be fitted and fixed to the outer cylindrical member at the protrusion.

7. A rigid spacer ring band for use in a vibration damping bushing assembly wherein a vibration-damping bushing including: a rigid outer cylindrical member having a radially outward-facing flange at one axial end; a rigid inner cylindrical member disposed inside the outer cylindrical member; and a rubber elastic body interposed between and elastically connecting the outer and inner cylindrical members, and wherein the vibration-damping bushing is axially press-fit into a rigid cylindrical retainer of a companion member to be assembled therewith at an outer circumferential surface of the outer cylindrical member, characterized in that:
said rigid spacer ring of annular shape is adapted to be mounted while externally fitted by means of axial pressure on the circumferential surface of the outer cylindrical member so that the flange of the outer cylindrical member and an end surface of the cylindrical retainer being brought into axial contact through the spacer ring band; and
the spacer ring band being partially provided with at least one protrusion protruding on an inner circumferential surface so as to be fitted and fixed to the outer cylindrical member at the protrusion.
